(19) United States
(12) Patent Application Publication
(10) Pub. No.: US 2014/0035339 A1
(43) Pub. Date: Feb. 6, 2014

(54) REVERSIBLE SEAT STRUCTURE FOR BABY STROLLER

(71) Applicant: Kao-Hsien LIN, Surrey (CA)

(72) Inventor: Kao-Hsien LIN, Surrey (CA)

(21) Appl. No.: 13/564,007

(22) Filed: Aug. 1, 2012

(51) Int. Cl. B60N 2/22; B60N 2/26

(52) U.S. Cl. 297/354.12; 297/440.15

(57) ABSTRACT

A reversible seat structure for a baby stroller is disclosed. The seat of the structure can be separated from or quickly assembled with a frame; a user thus has an option of turning the seat toward the front or the back side for assembling the seat on a frame. The structure mainly is provided with a front slip joint and a rear slip joint respectively on front ends and rear ends of the seat tubes of the seat for the baby stroller, the rear legs on both lateral sides of the baby stroller each has a positioning member at a mutually identical height thereon; the seat can be firmly combined with the frame of the baby stroller no matter the seat is faced frontwards or backwards.

### BACKGROUND OF THE INVENTION

1. Field of the Invention

The present invention relates to a seat structure for a baby stroller, and especially to a reversible seat structure applicable to reverse direction of the seat from facing forward to backward or vice versa.

2. Description of the Prior Art

A baby stroller is a vehicle for seating therein a baby in order to make convenience for parents using the baby stroller to push the baby easily when they go out. As shown in FIG. 1, a conventional structure for a baby stroller comprises a frame 100, and a seat 200 which is mounted on the frame 100. The frame 100 includes two rear legs 101 on the rear end of the seat 200, and two front legs 102 on the front end of the seat 200 respectively. The front legs 102 are respectively provided on the top ends thereof with push rods 103 for a parent to apply force to push the baby stroller. Two tilting middle supporting rods 104 are provided between the front legs 102 and the rear stands 101. The two middle supporting rods 104 are provided each with a backrest supporting rod 105, thereby the seat 200 can be mounted on the two middle supporting rods 104 and the backrest supporting rod 105 for seating of a baby.

The seat 200 of the above stated baby stroller is combined with and fixed to the frame 100, it is unable for us to change by rotation the facing direction of the seat. Consequently when a baby sits in the baby stroller, his face is facing to the front, parents are always standing on the back side of the baby to push the baby stroller, and they are unable to see expression on the baby's face; on account of being unable to see parents, the baby tends to have restless emotion. Therefore, if a baby can see parents when seating in a baby stroller, and parents can communicate with the baby when pushing the baby stroller forward, it is inevitable that the baby will have more feeling of security, and have fewer opportunities of crying.

While among the commercial products, there is a baby stroller which allows turning the direction of a pusher rod which is originally inclined to the rear, so parents can stand in front of the baby stroller, facing to the seat, and can push the baby stroller toward the reverse direction. There is no doubt that this kind of design can solve the problems stated above, however, with respect to the frame, it should be considered about the centre of gravity of the frame after changing the direction with a push rod, and the front wheels are required to be installed with an extra brake device, therefore, design for this is more complicated, the cost is higher, and the volume and weight for this are respectively increased as well. Not most of the parents are willing to select this for use.

In view of these, the inventor of the present invention developed a reversible seat structure for a baby stroller based on his professional experiences of years on studying and practicing in corresponding area, wherein lightness and stability of the baby stroller is kept to the best in order that a user has an option of turning the seat to the front or the back side, and after that the seat can be assembled quickly for seating of the baby therein.

### SUMMARY OF THE INVENTION

The main object of the present invention is to provide a reversible seat structure for a baby stroller, wherein lightness and stability of the baby stroller is kept to the best in order that a user has an option of turning the seat to the front or the back side for seating of the baby therein, thereby parents can communicate with the baby when in pushing the baby stroller forward.

To obtain the abovementioned object, the seat for the baby stroller of the present invention can be separated from or quickly assembled with a frame, so that the user has an option of turning the seat toward the front or the back side for assembling the seat on the frame. The frame comprises two rear legs respectively at two lateral sides, and two front legs respectively at the two lateral sides too, and two middle supporting rods connected each between one of the rear legs and one of the front legs. Each of the middle supporting rods is in the shape of a rectangular tube and the rear section thereof is pivotally connected with the lower portion of the corresponding rear leg, the middle supporting rod inclines from the rear section upwardly to a length of distance and then is bent, and extends forward to form its front section to be pivotally connected with the corresponding front leg. The scat structure for the baby stroller of the present invention is characterized in: the seat for the baby stroller includes two lateral back tubes, two lateral seat tubes, and a seat cloth provided on the lateral back tubes and the lateral seat tubes, the front ends and the rear ends of the two seat tubes are provided each with a front slip joint and a rear slip joint, the rear legs on both lateral sides of the baby stroller each has a positioning member at a mutually identical height thereon; when the seat is faced frontwards toward the seat tubes which are mounted respectively above the front sections on the middle supporting rods, the front slip joints and the rear slip joints which can be respectively connected with the front ends as well as the rear ends of the front sections on the middle supporting rods, the seat can be assembled firmly with the frame of the baby stroller; when in changing the facing direction of the seat toward the back, the rear slip joints of the seat tubes at both lateral sides of the seat can be respectively connected with the rear ends of the two middle supporting rods, in addition, the two front slip joints can be connected with the positioning members of the abovementioned rear legs at both lateral sides of the baby stroller respectively in order to hold the seat firmly after changing the direction.

The way of implementation of each component is now further described as below:

In practicing of the front slip joints, each of them is comprised of a first insertion groove fixed on the seat tube provided on the front end of the seat, and a second insertion groove located beneath the first insertion groove; the second insertion groove is in a rectangular shape, when the seat is faced to the front, each second insertion groove which is mounted on one of the two lateral sides of the front slip joints is firmly slipped over a corresponding one of the front ends provided in the front sections of the middle supporting rods at the two lateral sides.

The rear ends provided in the abovementioned front sections of the middle supporting rods on both lateral sides are provided with convex protrusions protruding outwardly of both lateral sides. In practicing, each of the rear slip joints has a connecting part being fixedly mounted on the rear end of its corresponding seat tube of the seat and having a cross-section in an L-shape or a U-shape, and has a connecting sleeve being stretched downward from the connecting part and having a cross-section in an inverted U-shape, and the connecting sleeves are provided at the positions thereon corresponding to that of the convex protrusions in the rear ends on the front sections of the middle supporting rods at both lateral sides with two transverse positioning grooves; as the seat tubes at both lateral sides are mounted respectively on the tops of the front sections of the middle supporting rods at both the lateral sides, the connecting sleeves of the rear slip joints in the inverted U-shape can be respectively slipped over the corresponding rear ends of the front sections on the middle supporting rods, and the two transverse positioning grooves can have the convex protrusions fixedly embedded therein.

Furthermore, the outside surface of each of the rear slip joints is further provided with a stop lid for pivoting relatively to the rear slip joint itself, the stop lid is provided thereon at a corresponding position to that of the convex protrusion and on the outside surface of the rear end located at the front section on the middle supporting rod with a fixing hole; after the two stop lids pivots in order that the fixing holes are slipped over the outside surfaces of the corresponding convex protrusions, a situation that the two rear slip joints provided in the corresponding middle supporting rods being displaced up-and-down or left-and-right can be avoided, in order to strengthen stability of the seat.

In practicing of each of the positioning members, it is comprised of a fixing part being fixed on the rear leg, a mounting part which is provided on a lateral side of the fixing part and has a cross-section in an inverted L-shape for mounting of the front end of a corresponding seat tube, and an insertion connecting block below the mounting part to allow assembling of the front end of the second insertion groove of the corresponding front slip joint; the insertion connecting block is in a rectangular shape, when the seat faces to the rear, the front ends of the two seat tubes of the seat are respectively mounted on the L-shaped mounting parts of the corresponding positioning members, and the insertion connecting blocks of the two positioning members are respectively received in the second insertion grooves of the two corresponding front slip joints, in order to get the effect of fixing the seat.

By means of the above stated structure, when the seat faces to the front, the front ends of the seat tubes which are mounted at both lateral sides of the seat are respectively assembled with the front ends of the front sections of the two middle supporting rods by means of the second insertion grooves of the corresponding front slip joints; the rear ends of the seat tubes which are mounted at both lateral sides of the seat can be respectively slip connected over the rear ends of the front sections on the two middle supporting rods by means of the connecting sleeves of the corresponding rear slip joints. Meanwhile, the convex protrusion on the outside surface of each of the middle supporting rods is embedded in one of the transverse positioning grooves, then the two stop lids separately pivot in order that the fixing holes are slipped over the outside surfaces of the corresponding convex protrusions, this renders the seat to be locked and positioned to avoid shaking. When the user is ready to change the facing direction of the seat to the rear, the stop lids of the two rear slip joints can be opened in order that the fixing holes of the stop lids are removed from the outside surface of their corresponding convex protrusions, and the fixing status is relieved, then the seat is pulled out along the reverse direction of assembling, in order that the seat, the two front slip joints as well as the two rear slip joints are removed from the frame; after changing the facing direction of the seat, the front ends of the seat tubes are respectively mounted on the mounting parts of the corresponding positioning members, and the connecting sleeves of the two rear slip joints can be respectively slipped over the rear ends of front sections on the two middle supporting rods, in order that the second insertion groove on each of the front slip joints is assembled with the insertion connecting block on one of the positioning members, and the convex protrusion on the outside surface of each of the middle supporting rods is embedded in one of the transverse positioning grooves, then the two stop lids separately pivot so that the fixing holes are slipped over the outside surfaces of the corresponding convex protrusions, this renders the seat which has its facing direction changed to be locked and positioned to avoid shaking; therefore, the user can communicate with the baby face to face when in pushing the baby stroller forward. Besides, a lateral side on each rear slip joint is further provided with a backrest adjuster, the backrest adjuster is mounted on a position of the connecting part in corresponding to that near the inner area on the rear end of the seat tube for the seat, both the backrest adjusters are provided respectively for assembling of the two rear back tubes of the seat, so that the seat is adapted for adjusting the angle of inclination of a seat back, so that the baby can be cozier in seating.

In comparison with conventional techniques, the present invention has the function of changing the forward/backward facing directions of the seat under the circumstances of keeping lightness and stability of the baby stroller, the user thus has the option of turning the seat to face to the forward or backward direction for seating of the baby therein, the user can thereby communicate with the baby when in pushing the baby stroller forward.

Based on the technical means of the present invention, the followings give a practicing way to describe the present invention with reference to the accompanying drawings.

### BRIEF DESCRIPTION OF THE DRAWINGS

FIG. 1 is a perspective schematic view showing a conventional baby stroller;

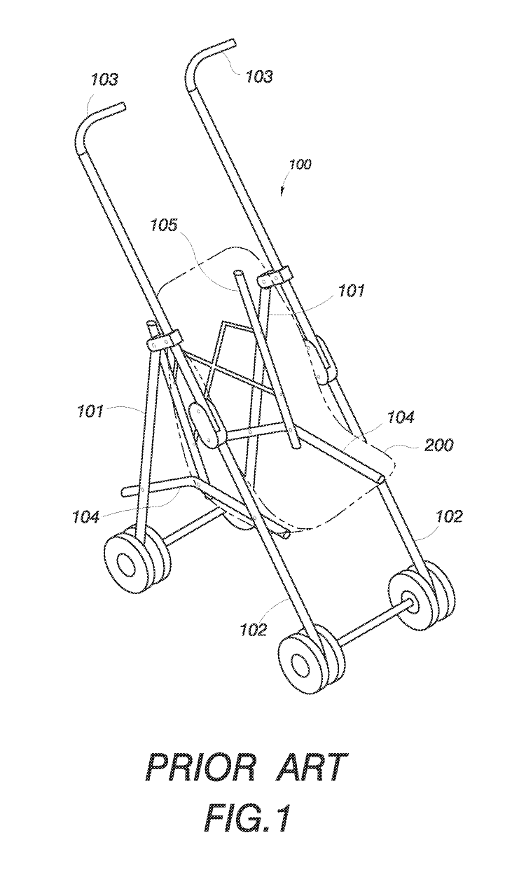

FIG. 2 is an analytic perspective schematic view showing the allocation of parts of the present invention;

FIG. 3 is an analytic perspective view of the present invention;

FIG. 4 is a schematic view showing the steps of assembling of the present invention;

FIG. 5 is another schematic view showing the steps of assembling of the present invention;

FIG. 6 is another analytic perspective view of the present invention attainted by taking another viewing angle;

FIG. 7 is another schematic view showing the steps of assembling of the present invention;

FIG. 8 is a further schematic view showing the steps of assembling of the present invention;

FIG. 9 is a partial analytic perspective view of the second embodiment of the present invention;

### DETAILED DESCRIPTION OF THE PREFERRED EMBODIMENT

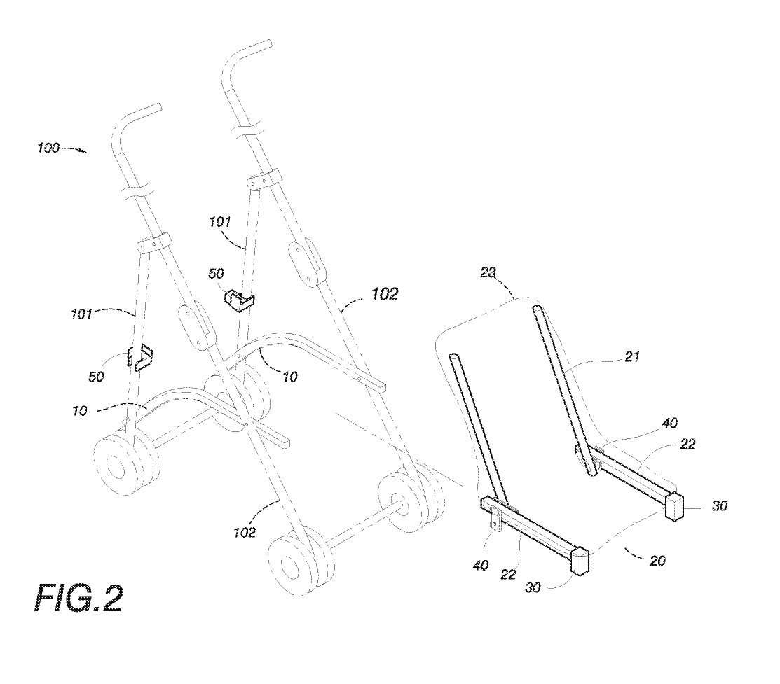

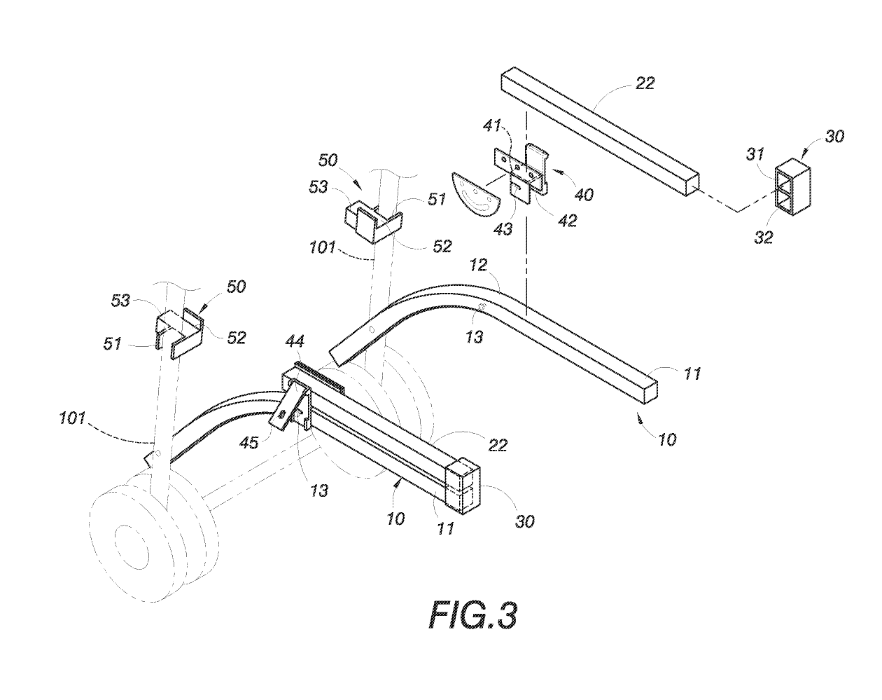

As shown in FIGS. 2 and 3, the reversible structure of a baby stroller has a seat 20 can be separated from or quickly assembled with a frame 100, in order that a user has an option of turning the seat toward the front or the back side for assembling the seat 20 on a frame 100. The frame 100 comprises two rear legs 101 at two lateral sides, and two front legs 102 respectively at the two lateral sides too, and two middle supporting rods 10 connected each between one of the rear legs 101 and one of the front legs 102. Each of the middle supporting rods 10 is in the shape of a rectangular tube and the rear section thereof is pivotally connected with the lower portion of the corresponding rear leg 101, the middle supporting rod 10 inclines from the rear section upwardly to a length of distance and then is bent, and extends forward to form its front section to be pivotally connected with the corresponding front leg 102. The seat structure for the baby stroller of the present invention is characterized in: the seat 20 for the baby stroller includes two lateral back tubes 21, two lateral seat tubes 22, and a seat cloth 23 provided on the lateral back tubes 21 and the lateral seat tubes 22, the front ends and the rear ends of the two seat tubes 22 are provided each with a front slip joint 30 and a rear slip joint 40, the rear legs 101 on both lateral sides of the baby stroller each has a positioning member 50 at a mutually identical height thereon; when the seat 20 is faced frontwards toward the seat tubes 22 which are mounted respectively above the front sections on the middle supporting rods 10, through the front slip joints 30 and the rear slip joints 40 which can be respectively connected with the front ends 11 as well as the rear ends 12 of the front sections on the middle supporting rods 10, the seat 20 can be assembled firmly with the frame 100 of the baby stroller; when in changing the facing direction of the seat 20 toward the back, the rear slip joints 40 of the seat tubes 22 at both lateral sides of the seat 20 can be respectively connected with the rear ends 12 of the two middle supporting rods 10, in addition, the two front slip joints 30 can be connected with the positioning members 50 of the abovementioned rear legs 101 at both lateral sides of the baby stroller respectively in order to hold the seat 20 firmly after changing the facing direction.

The way of implementation of each component is now further described as below:

In practicing of the front slip joints 30, each of them is comprised of a first insertion groove 31 fixed on the seat tube 22 provided on the front end of the seat 20, and a second insertion groove 32 located beneath the first insertion groove 31; the second insertion groove 32 is in a rectangular shape, when the seat 20 is faced to the front, each second insertion groove 32 which is mounted at one of the two lateral sides of the front slip joints 30 is firmly slipped over a corresponding one of the front ends 11 provided in the front sections of the middle supporting rods 10 at the two lateral sides.

The rear ends 12 provided in the abovementioned front sections of the middle supporting rods 10 on both lateral sides are provided with convex protrusions 13 protruding outwardly of both lateral sides. In practicing, each of the rear slip joints 40 has a connecting part 41 being fixedly mounted on the rear end of its corresponding seat tube 22 of the seat 20 and having a cross-section in an L-shape or a U-shape, and has a connecting sleeve 42 being stretched downward from the connecting part 41 and having a cross-section in an inverted U-shape, and the connecting sleeves 42 are provided at the positions thereon corresponding to that of the convex protrusions 13 in the rear ends 12 on the front sections of the middle supporting rods 10 at both lateral sides with two transverse positioning grooves 43; as the seat tubes 22 at both lateral sides are mounted respectively on the tops of the front sections of the middle supporting rods 10 at both the lateral sides, the connecting sleeves 42 of the rear slip joints 40 in the inverted U-shape can be respectively slipped over the corresponding rear ends 12 of the front sections on the middle supporting rods 10, and the two transverse positioning grooves 43 can have the convex protrusions 13 fixedly embedded therein.

Furthermore, the outside surface of each of the rear slip joints 40 is further provided with a stop lid 44 for pivoting relatively to the rear slip joint 40 itself, the stop lid 44 is provided thereon at a corresponding position to that of the convex protrusion 13 and on the outside surface of the rear end 12 located at the front section on the middle supporting rod 10 with a fixing hole 45; after the two stop lids 44 pivots in order that the fixing holes 45 are slipped over the outside surfaces of the corresponding convex protrusions 13, a situation that the two rear slip joints 40 provided in the corresponding middle supporting rods 10 being displaced up-and-down or left-and-right can be avoided, in order to strengthen stability of the seat 20.

In practicing of each of the positioning members 50, it is comprised of a fixing part 51 being fixed on the rear leg 101, a mounting part 52 which is provided on a lateral side of the fixing part 51 and has a cross-section in an inverted L-shape for mounting of the front end of a corresponding seat tube 22, and an insertion connecting block 53 below the mounting part 52 to allow assembling of the front end of the second insertion groove 32 of the corresponding front slip joint 30; the insertion connecting block 53 is in a rectangular shape, when the seat 20 faces to the rear, the front ends of the two seat tubes 22 of the seat 20 are respectively mounted on the L-shaped mounting parts 52 of the corresponding positioning members 50, and the insertion connecting blocks 53 of the two positioning members 50 are respectively received in the second insertion grooves 32 of the two corresponding front slip joints 30, in order to get the effect of fixing the seat 20.

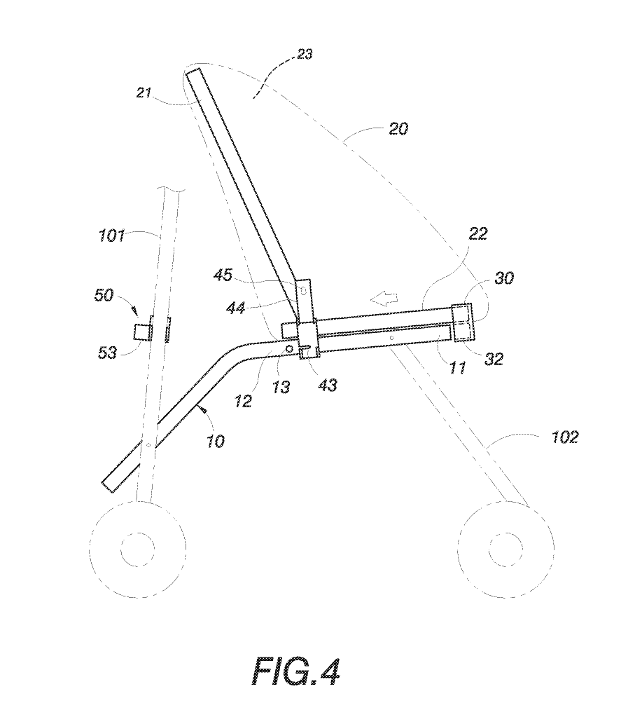

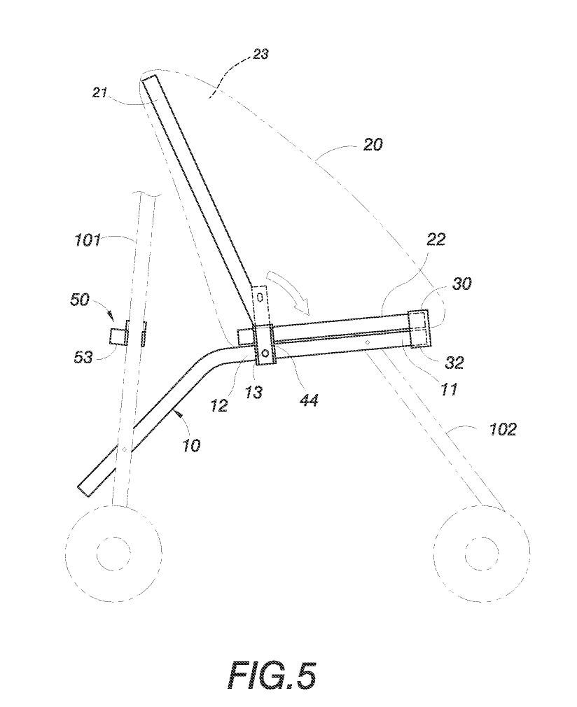

Referring to FIGS. 3, 4, and 5, when the seat 20 faces to the front, the front ends of the seat tubes 22 which are mounted at both lateral sides of the seat 20 are respectively assembled with the front ends 11 of the front sections of the two middle supporting rods 10 by means of the second insertion grooves 32 of the corresponding front slip joints 30; the rear ends of the seat tubes 22 which are mounted at both lateral sides of the seat 20 can be respectively slip connected over the rear ends 12 of the front sections on the two middle supporting rods 10 by means of the connecting sleeves 42 of the corresponding rear slip joints 40. Meanwhile, the convex protrusion 13 on the outside surface of each of the middle supporting rods 10 is embedded in one of the transverse positioning grooves 43, then the two stop lids 44 separately pivot in order that the fixing holes 45 are slipped over the outside surfaces of the corresponding convex protrusions 13, this renders the seat 20 to be locked and positioned to avoid shaking.

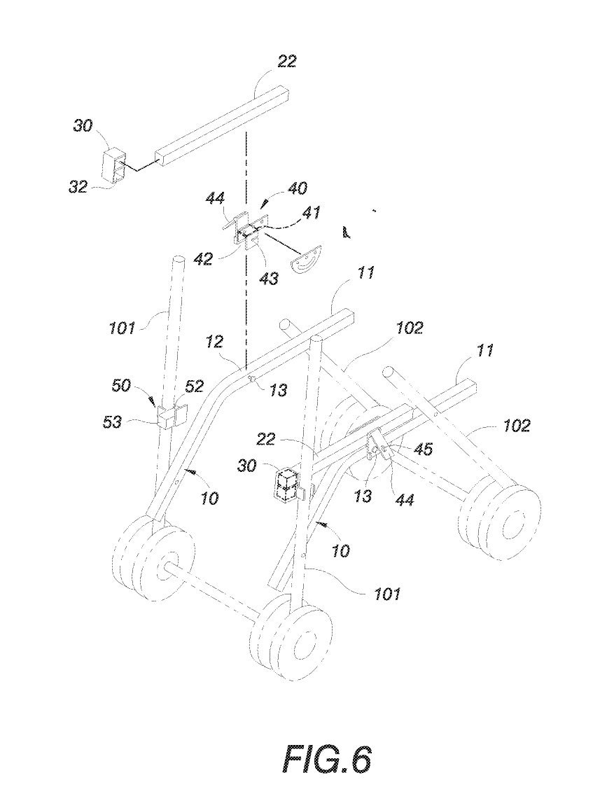

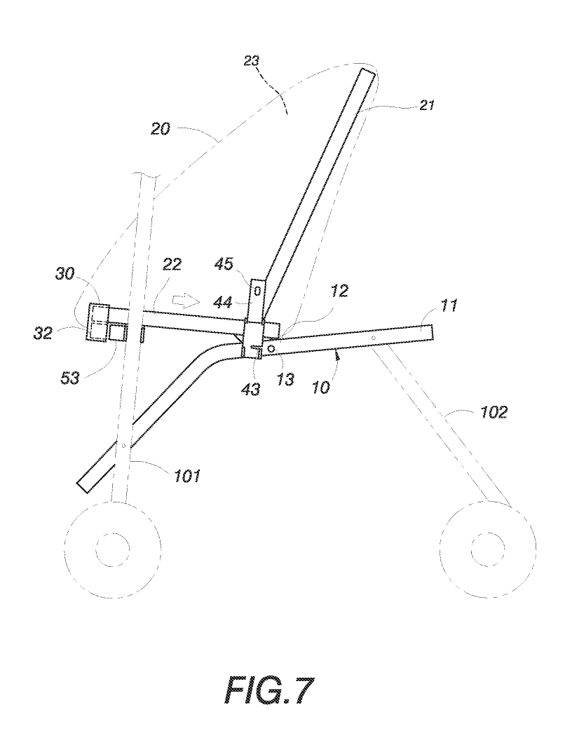

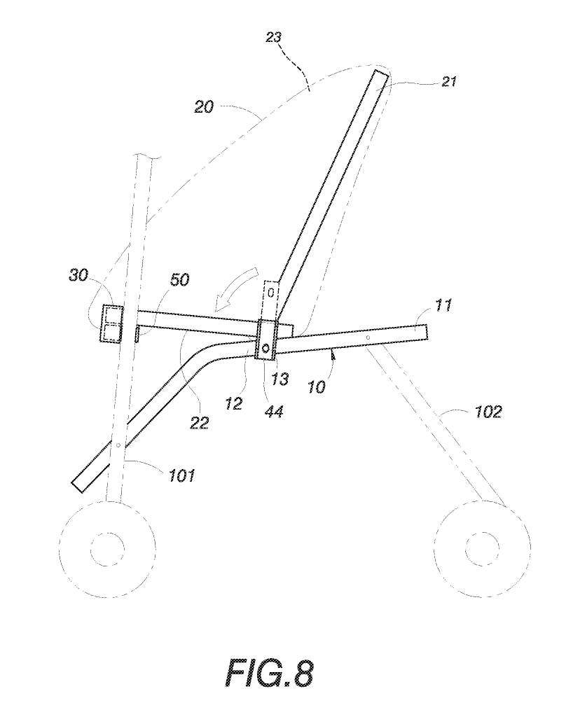

When the user is ready to change the facing direction of the seat 20 to the rear, the stop lids 44 of the two rear slip joints 40 can be opened in order that the fixing holes 45 of the stop lids 44 are removed from the outside surface of their corresponding convex protrusions 13, and the fixing status is relieved, then the seat 20 is pulled out along the reverse direction of assembling, in order that the seat 20, the two front slip joints 30 as well as the two rear slip joints 40 are removed from the frame 100; referring to FIGS. 6, 7, and 8, after changing the facing direction of the seat 20, the front ends of the seat tubes 22 are respectively mounted on the mounting parts 52 of the corresponding positioning members 50, and the connecting sleeves 42 of the two rear slip joints 40 can be respectively slipped over the rear ends 12 of the front sections on the two middle supporting rods 10, in order that the second insertion groove 32 on each of the front slip joints 30 is respectively assembled with the insertion connecting block 53 on one of the positioning members 50, and the convex protrusion 13 on the outside surface of each of the middle supporting rods 10 is embedded in one of the transverse positioning grooves 43, then the two stop lids 44 pivot so that the fixing holes 45 are slipped over the outside surfaces of the corresponding convex protrusions 13, this renders the seat 20 which has its facing direction changed to be locked and positioned to avoid shaking, therefore, the user can communicate with the baby face to face when in pushing the baby stroller forward.

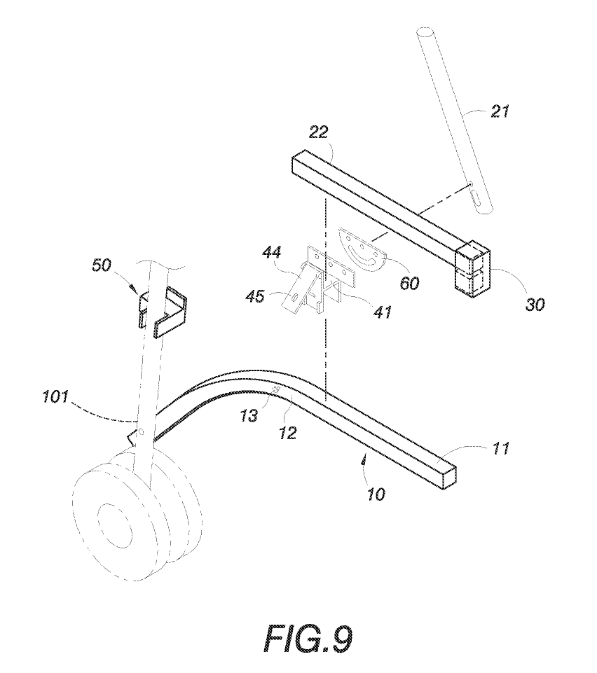

Besides, with reference to FIG. 9, a lateral side on each rear slip joint 40 is further provided with a backrest adjuster 60, the backrest adjuster 60 is mounted on a position of the connecting part 41 in corresponding to that near the inner area on the rear end of the seat tube 22 for the seat 20 and having a cross-section in an L-shape or a U-shape, both the backrest adjusters 60 are provided respectively for assembling of the two rear back tubes 21 of the seat 20, so that the seat 20 is adapted for adjusting the angle of inclination of a seat back, so that the baby can be cozier in seating.

The specification and the drawings for the present invention are only for illustrating a preferred embodiment of the present invention, and not forgiving any limitation to the scope of the present invention. It will be apparent to those skilled in this art that various equivalent modifications without departing from the spirit, scope and characteristic of this invention shall fall within the scope of the appended claims.

1. A reversible seat structure for a baby stroller, said structure comprises a frame and a seat, said seat is provided on said frame and is adapted to being separated from or quickly assembled with said frame; said frame includes two rear legs at two lateral sides, two front legs at said two lateral sides, and two middle supporting rods connected each between one of said rear legs and one of said front legs; each of said middle supporting rods is in a shape of a rectangular tube, and a rear section of each said middle supporting rod is pivotally connected with a lower portion of a corresponding one of said rear leg, said middle supporting rod inclines from said rear section upwardly to a length of distance and then is bent, and extends forward to form its front section to be pivotally connected with said corresponding front leg; said seat structure for said baby stroller is characterized in:
said seat for said baby stroller includes two lateral back tubes, two lateral seat tubes, and a seat cloth provided on said lateral back tubes and said lateral seat tubes, two front ends and two rear ends of said two seat tubes are respectively provided each with a front slip joint and a rear slip joint, said rear legs on both lateral sides of said baby stroller each has a positioning member at a mutually identical height thereon; when said seat is faced frontwards toward said seat tubes which are mounted respectively above said front sections on said middle supporting rods, said front slip joints and said rear slip joints which are respectively connected with said front ends as well as said rear ends of said front sections on said middle supporting rods; when in changing facing direction of said scat backwards, said rear slip joints of said seat tubes at both lateral sides of said seat are respectively connected with said rear ends of said two middle supporting rods, in addition, said two front slip joints are adapted to being connected with said positioning members of said rear legs on both lateral sides of said baby stroller respectively in order to hold said seat firmly after changing said facing direction.

2. The reversible seat structure for a baby stroller as stated in claim 1, wherein each of said front slip joints is comprised of a first insertion groove fixed on said front end of said seat tube, and a second insertion groove located beneath said first insertion groove, said second insertion groove is in a rectangular shape, and is firmly slipped over a corresponding one of said front ends provided in said front sections of said middle supporting rods at said two lateral sides.

3. The reversible seat structure for a baby stroller as stated in claim 1, wherein said rear ends on said front sections of said middle supporting rods at both lateral sides are provided with convex protrusions protruding outwardly of both lateral sides; each of said rear slip joints has a connecting part being fixedly mounted on a rear end of a corresponding one of said seat tubes of said seat, and has a connecting sleeve being stretched downward from said connecting part and having a cross-section in an inverted U-shape, and said connecting sleeves are provided at positions thereon in corresponding to that of said convex protrusions in said rear ends on said front sections of said middle supporting rods at both lateral sides with two transverse positioning grooves; as said seat tubes at both lateral sides are mounted respectively on tops of said front sections of said middle supporting rods at both said lateral sides, said connecting sleeves of said rear slip joints in said inverted U-shape are respectively slipped over said corresponding rear ends of said front sections on said middle supporting rods, and said two transverse positioning grooves allow said convex protrusions fixedly embedded therein.

4. The reversible seat structure for a baby stroller as stated in claim 3, wherein each of said rear slip joint is further provided with a stop lid for pivoting relatively to said rear slip joint itself, said stop lid is provided thereon at a corresponding position to that of said convex protrusion and on an outside surface of said rear end located at said front section on said middle supporting rod with a fixing hole.

5. The reversible seat structure for a baby stroller as stated in claim 1, wherein each of said positioning members is comprised of a fixing part being fixed on said rear leg, a mounting part which is provided on a lateral side of said fixing part, and an insertion connecting block below said mounting part to allow assembling of a front end of said second insertion groove of said corresponding front slip joint; when said seat faces rearwards, said front ends of said two seat tubes of said seat are respectively mounted on said mounting parts of said corresponding positioning members, and said insertion connecting blocks of said two positioning members are respectively received in corresponding ones of said two front slip joints.

6. The reversible seat structure for a baby stroller as stated in claim 1, wherein a lateral side on each of said rear slip joints is further provided with a backrest adjuster, said backrest adjuster is mounted on a position of said connecting part in corresponding to that near an inner area on said rear end of said seat tube for said seat, said backrest adjusters are provided respectively for assembling of said two rear back tubes of said seat, so that said seat is adapted for adjusting an angle of inclination for a seat back.
